(19) United States
(12) Patent Application Publication
(10) Pub. No.: US 2022/0325202 A1
(43) Pub. Date: Oct. 13, 2022

(54) DETERGENT COMPOSITION

(71) Applicant: KAO CORPORATION, Tokyo (JP)

(72) Inventor: Ayako OKAMURA, Wakayama-shi, Wakayama (JP)

(73) Assignee: KAO CORPORATION, Tokyo (JP)

(21) Appl. No.: 17/763,748

(22) PCT Filed: Nov. 17, 2020
(86) PCT No.: PCT/JP2020/042753

§ 371 Date: Mar. 25, 2022

(30) Foreign Application Priority Data
Nov. 21, 2019 (JP) 2019-210102

(51) Int. Cl. C11D 1/831; C11D 11/00; D06L 1/12

(52) U.S. Cl. CPC C11D 1/831; C11D 11/0017; D06L 1/12; C11D 1/143

(57) ABSTRACT

The present invention is a detergent composition containing (A) an anionic surfactant, (B) a nonionic surfactant and water, wherein the composition contains (A1) an anionic surfactant having a hydrocarbon group and as acid- or salt-form sulfonic acid group as component (A), and one or two or more nonionic surfactants selected from the group consisting of (B1-1) a nonionic surfactant having a linear hydrocarbon group with 8 or more and 10 or less carbons and (B1-2) a nonionic surfactant having a branched hydrocarbon group with 8 or more and 22 or less carbons as component (B).

### FIELD OF THE INVENTION

The present invention relates to a detergent composition and a method for washing a textile product.

### BACKGROUND OF THE INVENTION

Conventionally, anionic surfactants, particularly alkylbenzene sulfonate salts have been widely used as domestic and industrial detergent components as they are excellent in detergency and foamability. As one of the anionic surfactants other than alkylbenzene sulfonate salts, olefin sulfonate salts, particularly internal olefin sulfonate salts obtained from raw material internal olefins having double bonds inside olefin chains rather than at the ends thereof have been reported. Further, it is also known that detergency against stains adhered to fibers is improved if nonionic surfactants having polyoxyethylene groups are contained.

JP-A 2014-76988 discloses an internal olefin sulfonate salt composition particularly excellent in foamability, foam quality, quick foamability and foam dissipation properties, especially foam quality, when used for hair washing, the composition comprising (A) an internal olefin sulfonate salt with 16 carbons and/or (B) an internal olefin sulfonate salt with 18 carbons, wherein the content mass ratio of component (A) to component (B), (A)/(B), is 0/100 to 70/30.

EP-A 0377261 discloses a detergent composition with excellent detergency comprising an internal olefin sulfonate salt comprising 25% or more of β-hydroxy species. Patent literature 2 states that the internal olefin sulfonate salt has preferably 12 to 20 carbons. Patent literature 2 discloses as specific examples granular laundry detergent compositions including an internal olefin sulfonate salt with 18 carbons and 25 mass % of zeolite A.

JP-A 2003-81935 discloses a detergent composition comprising an internal olefin sulfonate salt obtained by sulfonating, neutralizing and hydrolyzing an internal olefin with 8 to 30 carbons in which the total of the proportions of internal olefins with double bonds present at position 2 is 20 to 95% and cis species/trans species ratio is 1/9 to 6/4. In formulation example 1 of Patent literature 3, a granular detergent composition for clothes including an internal olefin sulfonate salt, a nonionic surfactant having a polyoxyethylene group and 25 mass % of zeolite is disclosed.

JP-A H3-126793 discloses a detergent composition comprising an internal olefin sulfonate salt derived from an internal olefin with 12 to 18 carbons and a nonionic surfactant with an HLB value of 10.5 or less at specific ratios. In Examples of patent literature 4, there is a description of detergency evaluations conducted by using an internal olefin sultanate salt with 18 carbons as a comparative example and using water whose ionic strength was adjusted by sodium chloride and sodium carbonate.

JP-A 2017-214567 discloses a detergent composition for fibers comprising an internal olefin sulfonate salt with 18 carbons, a nonionic surfactant with an HLB of more than 10.5 and a metal ion chelating agent.

### SUMMARY OF THE INVENTION

None of JP-A 2014-76988, EP-A 0377261, JP-A 2003-81935 and JP-A H3-126793 mention the problem of softening fibers while maintaining detergency against stains adhered to fibers. Further, although JP-A 2017-214567 mentions the problem of softening fibers while maintaining detergency, it makes no mention of the problem of maintaining detergency even if water different in hardness is used.

The present invention provides a detergent composition excellent in low-temperature stability and capable of softly finishing fibers while maintaining detergency against stains adhered to fibers even if water different in hardness is used for washing.

The present invention relates to a detergent composition containing (A) an anionic surfactant [hereinafter referred to as component (A)], (B) a nonionic surfactant [hereinafter referred to as component (B)] and water,

wherein the composition contains

(A1) an anionic surfactant having a hydrocarbon group and an acid- or salt-form sulfonic acid group [hereinafter referred to as component (A1)] as component (A), and

one or two or more nonionic surfactants [hereinafter referred to as component (B1)] selected from the group consisting of (B1-1) a nonionic surfactant having a linear hydrocarbon group with 8 or more and 10 or less carbons [hereinafter referred to as component (B1-1)] and (B1-2) a nonionic surfactant having a branched hydrocarbon group with 8 or more and 22 or less carbons [hereinafter referred to as component (B1-2)] as component (B).

Further, the present invention relates to a method for washing a textile product including, washing the textile product with a detergent liquid obtained by mixing the detergent composition of the present invention and water, and thereafter rinsing the textile product with water.

According to the present invention, provided are a detergent composition excellent in low-temperature stability and capable of softly finishing fibers while maintaining detergency against stains adhered to fibers even if water different in hardness is used for washing, and a method for washing a textile product.

### EMBODIMENTS OF THE INVENTION

### <Detergent Composition>

### [Component (A)]

Component (A) is an anionic surfactant.

The detergent composition of the present invention contains (A1) an anionic surfactant having a hydrocarbon group and an acid- or salt-form sulfonic acid group [hereinafter referred to as component (A1)] as component (A). Note that, in the present invention, as the content of component (A), a value calculated by assuming that a counterion or an anionic group of component (A) is a hydrogen ion, namely, a value in terms of the acid-form compound content is used. Mass ratios pertaining to component (A) are calculated using the content of component (A) expressed in terms of the acid-form compound content.

Examples of the hydrocarbon group of component (A1) include, for example, a linear or branched alkyl or alkenyl group. Note that, in the present invention, when an alkyl or alkenyl group has a secondary or tertiary carbon bonded to a sulfonic acid group, the alkyl or alkenyl group is a branched group.

The hydrocarbon group of component (A1) has preferably 7 or more, more preferably 8 or more and further preferably 12 or more carbons from the viewpoint of imparting softness fibers, and preferably 22 or less and more preferably 20 or less carbons from the viewpoint of improving the washing performance of the detergent composition.

The sulfonic acid group of component (A1) may form a salt. Examples of the salt include alkali metal salts such as a sodium salt, a potassium salt and the like, alkaline earth metal salts such as a calcium salt, a magnesium salt and the like, an ammonium salt, an alkanol ammonium salt, and others.

Component (A1) is preferably an anionic surfactant having one hydrocarbon group and one acid- or salt-form sulfonic acid group from the viewpoint of imparting softness to fibers.

Examples of component (A1) include an anionic surfactant represented by the following general formula (a1):

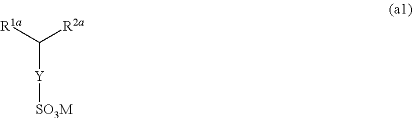

wherein each of R^{1a} and R^{2a} independently represents a hydrocarbon group with 1 or more and 28 or less carbons which may include a substituent or a linking group; Y represents a single bond or phenylene group; and M represents a counterion.

In the formula (a1), examples of the hydrocarbon groups of R^{1a} and R^{2a} incline an alkyl group, an alkenyl group and an aryl group. They are preferably alkyl groups or alkenyl groups.

Each of the hydrocarbon groups of R^{1a} and R^{2a} may include a substituent such as a hydroxyl group or the like or a linking group such as COO group or the like.

R^{1a} and R^{2a} preferably; have 7 or more, further 9 or more, further 15 or more and further 17 or more, and 29 or less, further 25 or less and further 21 or less carbons in total. Note that the numbers of carbons of substituents or linking groups are not included in the numbers of carbons of the hydrocarbon groups of R^{1a} and R^{2a}.

In the formula (a1), examples of M include an alkali metal ion, an alkaline earth metal (½ atom) ion, an ammonium ion or an organic ammonium ion. M is preferably an alkali metal ion, more preferably a sodium ion or a potassium ion, and further preferably a potassium ion.

Y is preferably a single bond.

Examples of component (A1) include one or two or more anionic surfactants selected from an internal olefin sulfonate salt, an alkylbenzene sulfonate salt, an alpha-sulfo fatty acid ester salt and a dialkyl sulfosuccinate salt, and one or two or more anionic surfactants selected from an internal olefin sulfonate salt and an alkylbenzene sulfonate salt are preferable and an internal olefin sulfonate salt is more preferable from the viewpoint of imparting softness.

The internal olefin sulfonate salt is preferably an internal olefin sulfonate salt having a hydrocarbon group with 8 or more and 22 or less carbons from the viewpoint of imparting softness. Hereinafter, an internal olefin sultanate salt may also be expressed as IOS. The number of carbons of a hydrocarbon group of IOS may be the number of carbons of an internal olefin with which a sultanate salt forms a covalent bond.

IOS can be obtained, for example, by the sulfonation, neutralization, hydrolysis and the like of internal olefins having double bonds inside (at position 2 or higher of) olefin chains. The sulfonation of the internal olefins quantitatively produces β-sultones, and part of the β-sultones changes into γ-sultones and olefin sulfonates, which further convert into hydroxy alkane sulfonate salts (H species) and olefin sulfonate salts (O species) during the neutralization and hydrolysis processes (e.g., J. Am. Oil Chem. Soc. 69, 39 (1992)). IOS is a mixture thereof and mainly sulfonate salts with sulfonic acid groups present inside (at position 2 or higher of) hydrocarbon chains (hydroxy alkane chains in H species and olefin chains in O species). The substitution position distribution of sulfonic acid groups in hydrocarbon chains of IOS can be quantified by a method such as gas chromatography, nuclear magnetic resonance spectroscopy or the like.

In IOS of component (A1), the proportion of IOS with a sulfonic acid group present at posit on 2 of a hydrocarbon group is preferably 5% or more, more preferably 10% or more and further preferably 20% or more, and preferably 45% or less and more preferably 30% or less on a mass basis from the viewpoint of imparting softness.

In IOS of component (A1), the proportion of IOS with a sulfonic acid group present at position 1 of a hydrocarbon group is preferably 0.2% or more, more preferably 1% or more and further preferably 2% or more, and preferably 20% or less, more preferably 10% or less, further preferably 5% or less and furthermore preferably 3% or less on a mass basis from the viewpoint of imparting softness.

The hydrocarbon group of IOS of component (A1) has preferably 8 or more, more preferably 10 or more, further preferably 16 or more and furthermore preferably 18 or more carbons from the viewpoint of imparting softness, and preferably 22 or less and further preferably 20 or less carbons from the viewpoint of improving washing performance. From the viewpoint of imparting softness, the detergent composition of the present invention more preferably contains IOS, further preferably contains IOS having a hydrocarbon group with 8 or more and 22 or less carbons, furthermore preferably contains IOS having a hydrocarbon group with 18 or more and 22 or less carbons and furthermore preferably contains IOS having a hydrocarbon group with 18 carbons as component (A1).

The hydrocarbon group of IOS of component (A1) is preferably a linear or branched alkyl group and more preferably a branched alkyl group from the viewpoint of imparting softness.

In IOS of component (A1), the proportion of IOS with 18 or more and 22 or less carbons is preferably 50 mass % or more, more preferably 70 mass % or more, further preferably 80 mass % or more, furthermore preferably 90 mass % or more, furthermore preferably 95 mass % or more and furthermore preferably 97 mass % or more, and preferably 100 mass % or less, or may be 100 mass % from the viewpoint of imparting softness.

In IOS having a hydrocarbon group with 8 or more and 22 or less carbons of component (A1), the molar ratio of H species to O species (H species/O species) is preferably 50/50 or more and more preferably 70/30 or more, and preferably 95/5 or less and more preferably 90/10 or less from the viewpoint of imparting softness.

Examples of anionic surfactants other than component (A1) include one or two or more selected from the group consisting of a sulfate salt, a carboxylate salt, a phosphate salt and an amino acid salt.

In the present invention, the proportion of component (A1) in component (A) is preferably 30 mass % or more, more preferably 50 mass % or more, further preferably 70 mass % or more and further preferably 90 mass % or more, and preferably 100 mass % or less, or may be 100 mass % from the viewpoint of imparting softness to fibers.

### [Component (B)]

Component (B) is a nonionic surfactant.

The detergent composition of the present invention contains one or two or more nonionic surfactants [hereinafter referred to as component (B1)] selected from (B1-1) a nonionic surfactant having a linear hydrocarbon group with 8 or more and 10 or less carbons [hereinafter referred to as component (B1-1)] and (B1-2) a nonionic surfactant having a branched hydrocarbon group with 8 or more and 22 or less carbons [hereinafter referred to as component (B1-2)] as component (B).

Note that, in the present invention, when a nonionic surfactant has a hydrocarbon group in which a carbon atom bonded to a hydrophilic part such as an alkyleneoxy group or the like is a secondary or tertiary carbon, the nonionic surfactant is also a nonionic surfactant having a branched hydrocarbon.

Examples of the hydrocarbon group of component (B1-1) include a group selected from a linear alkyl group and a linear alkenyl group, and a linear alkyl group is preferable from the viewpoint of availability. Component (B1-1) is preferably a nonionic surfactant having one linear hydrocarbon group with 8 or more and 10 or less carbons from the viewpoints of improving washing performance and imparting softness. The hydrocarbon group of component (B1-1) has preferably 10 carbons from the viewpoint of imparting softness.

Examples of the hydrocarbon group of component (B1-2) include a group selected from a branched alkyl group and a branched alkenyl group, and a branched alkyl group is preferable from the viewpoint of availability. Component (B1-2) is preferably a nonionic surfactant having one branched hydrocarbon group with 8 or more and 22 or less carbons from the viewpoints of improving washing performance and imparting softness.

Component (B1) may be a nonionic surfactant with an HLB of preferably 11.5 or more and more preferably 12.5 or more, and preferably 15.4 or less and more preferably 15.1 or less from the viewpoint of improving washing performance.

This HLB is based on Griffin's method. Here, when component (B1) includes a polyoxyethylene group, the HLB refers to HLB calculated by the following formula:

HLB=[(average molecular weight of polyoxyethylene group)/(average molecular weight of component (B1))]×20

wherein average molecular weight of polyoxyethylene group represents average molecular weight calculated from the average number of added moles of oxyethylene groups when the numbers of added moles thereof have a distribution; and average molecular weight of component (B1) is molecular weight calculated as an average value when hydrophobic groups such as hydrocarbon groups or the like have a distribution or the numbers of added moles of polyoxyethylene groups have a distribution.

Note that the above oxyethylene groups may be referred to as an ethyleneoxy group in specific examples of nonionic surfactants below.

Further, in the present invention, when component (B1) does not include a polyoxyethylene group, the HLB of component (B1) refers to the one measured by a method of Kunieda et al. described in “Journal of Colloid and Interface Science, Vol. 107, No. 1, September, 1985.” The method for measuring HLB in this literature is based on the finding that there is a linear relationship between a specific temperature (THLB) and Griffin's HLB number.

Examples of component (B1-1) include a nonionic surfactant represented by the following general formula (b1-1):

R¹—O—(A¹O)ₙ₁—R² (b1-1)

wherein R¹ is a linear hydrocarbon group with 8 or more and 10 or less carbons; R² is a hydrogen atom or a methyl group; A¹O group is one or more groups selected from an ethyleneoxy group and a propyleneoxy group; and n1 is an average number of added moles and a number selected from the numbers 3 or more and 50 or less.

In the general formula (b1-1), R¹ is a linear hydrocarbon group with 8 or more and 10 or less carbons, and preferably a linear hydrocarbon group with 10 carbons from the viewpoint of imparting softness.

The linear hydrocarbon group of R¹ is preferably a group selected from a linear primary alkyl group and a linear primary alkenyl group and more preferably a linear primary alkyl group from the viewpoint of imparting softness.

In the general formula (b1-1), R² is preferably a hydrogen atom from the viewpoint of imparting softness.

In the general formula (b1-1), A¹O group is one or more groups selected from an ethyleneoxy group and a propyleneoxy group. When an ethyleneoxy group and a propyleneoxy group are included, the ethyleneoxy group and the propyleneoxy group may be bonded in blocks or bonded at random. A¹O group is preferably a group including an ethyleneoxy group from the viewpoint of imparting softness. The HLB value becomes higher when A¹O group is an ethleneoxy group than when A¹O group is a propyleneoxy group.

In the general formula (b1-1), n1 is an average number of added moles and a number selected from the numbers 3 or more and 50 or less. The larger the number n1 is, the higher the HLB value is, and the smaller the number n1 is, the lower the HLB value is. n1 is 3 or more, preferably 5 or more and more preferably 7 or more from the viewpoint of ensuring the solubility of component (B1-1), and 50 or less, preferably 20 or less and more preferably 10 or less from the viewpoint of improving washing performance.

Component (B1-1) is preferably a polyoxyalkylene decyl or decenyl ether. The oxyalkylene preferably includes an oxyethylene. Component (B1-1) is more preferably a polyoxyethylene decyl or decenyl ether and more preferably a polyoxyethylene decyl ether.

Examples of component (B1-2) include a nonionic surfactant represented by the following general formula (b1-2):

R³ —O—(A²O)ₙ₂—R⁴ (b1-2)

wherein R³ is a branched hydrocarbon group with 8 or more and 22 or less carbons; R⁴ is a hydrogen atom or a methyl group; A²O group is one or more groups selected from an ethyleneoxy group and a propyleneoxy group; and n2 is an average number of added moles and a number selected from the numbers 3 or more and 50 or less.

In the general formula (b1-2), R³ is a branched hydrocarbon group with 8 or more and 22 or less carbons. R³ has 8 or more and preferably 10 or more carbons from the viewpoint of improving washing performance, and 22 or less, preferably 18 or less, more preferably 14 or less and further preferably 12 or less carbons from the viewpoint of imparting softness.

The branched hydrocarbon group of R³ is preferably a group selected from a branched alkyl group, a linear secondary alkyl group, a branched alkenyl group and a linear secondary alkenyl group and more preferably a group selected from a branched alkyl group and a linear secondary alkyl group. Note that a linear secondary alkyl group and a linear secondary alkenyl group are groups in which carbon atoms of R³ bonded to O (oxygen atom) in the general formula (b1-2) are secondary carbon atoms.

In the general formula (b1-2), R⁴ is preferably a hydrogen atom from the viewpoint of imparting softness.

In the general formula (b1-2), A²O group is one or more groups selected from an ethyleneoxy group and a propyleneoxy group. When an ethyleneoxy group and a propyleneoxy group are included, the ethyleneoxy group and the propyleneoxy group may be bonded in blocks or bonded at random. A²O group is preferably a group including an ethyleneoxy group from the viewpoint of imparting softness. The HLB value becomes higher when A²O group is an ethyleneoxy group than when A²O group is a propyleneoxy group.

In the general formula (b1-2), n2 is an average number of added moles and a number selected from the numbers 3 or more and 50 or less. The larger the number n2 is, the higher the HLB value is, and the smaller the number n2 is, the lower the HLB value is. n2 is 3 or more, preferably 5 or more, more preferably 7 or more and further preferably 9 or more from the viewpoint of ensuring the solubility of component (B1-2), and 50 or less, preferably 20 or less and more preferably 10 or less from the viewpoint of improving detergency.

Component (B1-2) is preferably an alkylene oxide adduct of a Guerbet alcohol with 8 or more and 22 or less carbons from the viewpoints of imparting softness and improving washing performance. The alkylene oxide preferably includes ethylene oxide from the same viewpoints. Component (B1-2) is more preferably an alkylene oxide adduct and further an ethylene oxide adduct of a Guerbet alcohol with 10 carbons from the same viewpoints.

The detergent composition of the present invention may contain as component (B) one or two or more nonionic surfactants selected from (B1-1) a nonionic surfactant represented by the general formula (b1-1), and (B1-2) a nonionic surfactant represented by the general formula (b1-2).

The detergent composition of the present invention may contain as component (B) a nonionic surfactant other than component (B1) [hereinafter referred to as component (B2)]. Examples of the nonionic surfactant of component (B2) include, for example, a nonionic surfactant represented by the general formula (b1-1) the structure of which is modified such that R¹ is a linear hydrocarbon group with 11 or more carbons, a nonionic surfactant represented by the general formula (b1-2) the structure of which is modified such that R³ is a branched hydrocarbon group with 23 or more carbons, and the like.

Examples of component (B2) include a nonionic surfactant represented by the following general formula (b2):

R⁵—O—(A³O)ₙ₃—R⁶ (b2)

wherein R⁵ is a linear hydrocarbon group with 11 or more carbons or a branched hydrocarbon group with 23 or more carbons; R⁶ is a hydrogen atom or a methyl group; A³O group is one or more groups selected from an ethyleneoxy group and a propyleneoxy group; and n3 is an average number of added moles and a number selected from the numbers 3 or more and 50 or less.

In the general formula (b2), R⁵ is a linear hydrocarbon group with 11 or more carbons or a branched hydrocarbon group with 23 or more carbons.

The linear hydrocarbon group of R⁵ is preferably a linear hydrocarbon group with 11 or more and 14 or less carbons from the viewpoint of imparting softness.

The linear hydrocarbon group of R⁵ is preferably a group selected from a linear primary alkyl group and a linear primary alkenyl group from the same viewpoint.

The branched hydrocarbon group of R⁵ is preferably group selected from a branched alkyl group, a linear secondary alkyl group, a branched alkenyl group and a linear secondary alkenyl group from the viewpoint of imparting softness. The branched hydrocarbon group preferably has 23 or more and 30 or less carbons from the same viewpoint.

In the general formula (b2), R⁶ is preferably a hydrogen atom from the same viewpoint.

In the general formula (b2), A³O group is one or more groups selected from an ethyleneoxy group and a propyleneoxy group. When an ethyleneoxy group and a propyleneoxy group are included, the ethyleneoxy group and the propyleneoxy group may be bonded in blocks or bonded at random. A³O group is preferably a group including an ethyleneoxy group from the viewpoint of imparting softness. The HLB value becomes higher when A³O group is an ethyleneoxy group than when A³O group is a propyleneoxy group.

In the general formula (b2), n3 is an average number of added moles and a number selected from the numbers 3 or more and 50 or less. The larger the number n3 is, the higher the HLB value is, and the smaller the number n3 is, the lower the HLB value is. n3 is 3 or more, preferably 5 or more and more preferably 7 or more from the viewpoint of ensuring the solubility of component (B2), and 50 or less, preferably 30 or less, more preferably 25 or less and further preferably 21 or less from the viewpoint of improving detergency.

In the present invention, the proportion of component (B1) in component (B) is preferably 30 mass % or more, more preferably 50 mass % or more and further preferably 70 mass % or more, and preferably 100 mass % or less, more preferably 90 mass % or less and further preferably 80 mass % or less, or may be 100 mass % from the viewpoint of imparting softness.

### [Composition and Others]

The detergent composition of the present invention contains component (A) in an amount of preferably 0.01 mass % or more, more preferably 0.1 mass % or more, further preferably 0.5 mass % or more, further preferably 1 mass % or more, further preferably 3 mass % or more and further preferably 5 mass % or more, and preferably 70 mass % or less, more preferably 60 mass % or less, further preferably 40 mass % or less, further preferably 20 mass % or less, further preferably 10 mass % or less and further preferably 8 mass % or less from the viewpoint of imparting softness.

The detergent composition of the present invention contains component (A1) in an amount of preferably 0.01 mass % or more, more preferably 0.1 mass % or more, further preferably 0.5 mass % or more, further preferably 1 mass % or more, further preferably 3 mass % or more and further preferably 5 mass % or more, and preferably 70 mass % or less, more preferably 60 mass % or less, further preferably 40 mass % or less, further preferably 20 mass % or less, further preferably 10 mass % or less and further preferably 8 mass % or less from the viewpoint of imparting softness.

The detergent composition of the present invention contains component (B) in an amount of preferably 0.01 mass % or more, more preferably 0.1 mass % or more, further preferably 0.5 mass % or more, further preferably 1 mass % or more, further preferably 3 mass % or more, further preferably 4 mass % or more and further preferably 5 mass % or more, and preferably 70 mass % or less, more preferably 40 mass % or less, further preferably 20 mass % or less, further preferably 10 mass % or less and further preferably 8 mass % or less from the viewpoints of improving the washing performance of the detergent composition of the present invention and ensuring the low-temperature stability thereof.

The detergent composition of the present invention contains component (B1) in an amount of preferably 0.01 mass % or more, more preferably 0.1 mass % or more, further preferably 0.5 mass % or more, further preferably 1 mass % or more, further preferably 3 mass % or more, further preferably 4 mass % or more and further preferably 5 mass % or more, and preferably 70 mass % or less, more preferably 40 mass % or less, further preferably 20 mass % or less, further preferably 10 mass % or less and further preferably 8 mass % or less from the viewpoints of improving the washing performance of the detergent composition of the present invention and ensuring the low-temperature stability thereof.

In the detergent composition of the present invention, the mass ratio of the content of component (A) to the content of component (B), (A)/(B), is preferably 0.1 or more, more preferably 0.5 or more and further preferably 0.8 or more from the viewpoints of improving washing performance and imparting softness, and preferably 10 or less, more preferably 3 or less and further preferably 1.2 or less from the same viewpoints.

In the detergent composition of the present invention, the mass ratio of the content of component (A1) to the content of component (B1), (A1)/(B1), is preferably 0.1 or more, more preferably 0.5 or more and further preferably 1 or more from the viewpoints of improving washing performance and imparting softness, and preferably 10 or less, more preferably 3 or less and further preferably 1.5 or less from the same viewpoints.

The detergent composition of the present invention can contain optional components other than components (A) and (B) in the range that the effects of the present invention are not impaired. Examples of such optional components include a surfactant other than components (A) and (B), a chelating agent, an alkali agent, an enzyme, an inorganic salt (for example, inorganic salt including calcium or magnesium).

The detergent composition of the present invention contains water. Water is used as the balance other than components (A) and (B) and optional components. The detergent composition of the present invention can contain water in an amount of, for example, 20 mass % or more and further 30 mass % or more, and 99 mass % or less and further 98 mass % or less. The detergent composition of the present invention may be a liquid detergent composition.

The detergent composition of the present invention has a pH of preferably 3 or more and more preferably 4 or more, and preferably 13 or less and more preferably 12 or less at 20° C. The pH can be measured by the following measuring method.

<Method for Measuring pH>

A composite electrode for pH measurement (manufactured by HORIBA, Ltd., glass slide-in sleeve type) is connected to a pH meter (pH/ion meter F-23 manufactures by HORIBA, Ltd.), and the power is turned on. A saturated potassium chloride aqueous solution (3.33 mole/L) is used as an internal solution of the pH electrode. Next, 100-mL beakers are filled respectively with a pH 4.01 standard solution (phthalate standard solution), a pH 6.86 standard solution (neutral phosphate standard solution) and a pH 9.18 standard solution (borate standard solution) and immersed in a constant temperature bath at 25° C. for 30 minutes. A calibration operation is performed in the order of pH 6.86→pH 9.18→pH 4.01 such that the electrode for pH measurement is immersed in each of the standard solutions adjusted to have a constant temperature for 3 minutes. A sample to be measured is adjusted to have 25° C., and the electrode of the pH meter is immersed in the sample, the pH of which is measured 1 minute later.

The detergent composition of the present invention is preferably for use in fibers and further for use in textile products.

The fibers may be either of hydrophobic fibers or hydrophilic fibers. Examples of hydrophobic fibers include, for example, protein fibers (milk protein casein fiber, promix and the like), polyamide fibers (nylon and the like), polyester fibers (polyester and the like), polyacrylonitrile fibers (acrylic and the like), polyvinyl alcohol fibers (vinylon and the like), polyvinyl chloride fibers (polyvinyl chloride and the like), polyvinylidene chloride fibers (vinylidene and the like), polyolefin fibers (polyethylene, polypropylene and the like), polyurethane fibers (polyurethane and the like), polyvinyl chloride/polyvinyl alcohol copolymer fibers (polychlal and the like), polyalkylene paraoxybenzoate fibers (benzoate and the like), polyfluoroethylene fibers (polytetrafluoroethylene and the like), glass fibers, carbon fibers, alumina fibers, silicone carbide fibers, rock wool (rock fibers), slag wool (slag fibers), metallic fibers (gold yarn, silver yarn, steel fiber) and others. Examples of hydrophilic fibers include, for example, seed hair fibers (cotton, cotton, kapok and the like), bast fibers (hemp, flax, ramie, cannabis, jute and the like), vein fibers (manila hemp, sisal hemp and the like), palm fibers, juncus, straw, animal hair fibers (wool, mohair, cashmere, camel hair, alpaca, vicuna, angora and the like), silk fibers (domestic silk and wild silk), feathers, cellulose fibers (rayon, polynosic, cupro, acetate and the like) and others.

The fibers are preferably fibers including cotton fibers from the viewpoint that the softness of fibers after washing with the detergent composition of the present invention is more likely to be felt. The fibers contain cotton fibers in an amount of preferably 5 mass % or more, more preferably 10 mass % or more, further preferably 15 mass % or more, furthermore preferably 20 mass % or more and furthermore preferably 100 mass % from the viewpoint of further improving the softness of fibers.

In the present invention, textile products mean woven fabrics, knitted fabrics, nonwoven fabrics and other fabrics using the above hydrophobic or hydrophilic fibers, and undershirts, T-shirts, dress shirts, blouses, slacks, caps, handkerchiefs, towels, knitwear, socks, underwear, tights and other products obtained from them, provided that the textile products are not limited thereto. The textile products are preferably textile products including cotton fibers from the viewpoint that the softness of fibers after washing with the detergent composition of the present invention is more likely to be felt. The textile products contain cotton fibers in an amount of preferably 5 mass % or more, more preferably 10 mass % or more, further preferably 15 mass % or more, furthermore preferably 20 mass % or more and furthermore preferably 100 mass % from the viewpoint of further improving the softness of fibers.

### <Washing Method>

The washing method of the present invention is a method for washing a textile product including, washing the textile product with a detergent liquid obtained by mixing the detergent composition of the present invention and water, and thereafter rinsing the textile product with water.

In other words, the washing method of the present invention is a method for washing a textile product including, washing the textile product with a detergent liquid obtained by mixing component (A), component (B) and water, and thereafter rinsing the textile product with water, wherein the detergent liquid contains component (A1) as component (A) and component (B1) as component (B).

The washing method using the detergent composition of the present invention provides constant detergency that does not greatly vary even if water different in hardness is used to prepare the detergent liquid or used for rinsing. In addition, it can impart favorable softness to textile products.

Water mixed with the detergent composition of the present invention (components (A) and (B)) and water used for rinsing can each have a hardness selected from the range of 1° dH or more, further 2° dH or more and further 3° dH or more, and 30° dH or less, further 25° dH or less, further 20° dH or less, further 18° dH or less and further 15° dH or less.

Here, hardness (° dH) used herein refers to calcium and magnesium concentrations in water expressed in terms of CaCO₃ concentrations, and 1 mg/L (ppm)=0.056° dH (1° dH=17.8 ppm).

The concentrations of calcium and magnesium for this hardness are determined by chelate titration using an ethylenediaminetetraacetic acid disodium salt.

A specific method for measuring the hardness of water used herein is explained below.

### <Method for Measuring Hardness of Water>

### [Reagent]

0.01 mol/l EDTA .2Na solution: 0.01 mol/l aqueous solution of disodium ethylenediaminetetraacetate (solution for titration, 0.01 M EDTA-Na2, manufactured by Sigma-Aldrich Co. LLC (SIGMA-ALDRICH))
Universal BT indicator (product name: Universal BT, manufactured by DOJINDO LABORATORIES)
Ammonia buffer solution for hardness measurement (solution prepared by dissolving 67.5 g of ammonium chloride in 570 ml of 28 w/v % ammonia water and making the total amount 1000 ml with deionized water)

### [Measurement of Hardness]

(1) 20 ml of sample water is collected in a conical beaker with a volumetric pipette.
   (2) 2 ml of ammonia buffer solution for hardness measurement is added.
   (3) 0.5 ml of Universal BT indicator is added. It is confirmed that the solution after addition is reddish purple.
   (4) While the conical beaker is shaken well, 0.01 mol/l EDTA .2Na solution is added dropwise from a burette, and the point of time when the sample water turns blue is taken as the end point of titration.
   (5) The total hardness is determined by the following calculation formula:

Hardness (° dH)=T×0.01×F×56.0774×100/A

T: titration amount of 0.01 mol/l EDTA .2Na solution (mL)

A: sample volume (20 mL, volume of sample water)

F: factor for 0.01 mol/l EDTA .2Na solution

The matters mentioned in the detergent composition of the present invention can appropriately be applied to the washing method of the present invention.

The content of component (A) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less from the viewpoint of imparting softness.

The content of component (A1) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less from the viewpoint of imparting softness.

The content of component (B) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less from the viewpoint of ensuring washing performance.

The content of component (B1) in the detergent liquid is preferably 0.001 mass % or more, more preferably 0.005 mass % or more and further preferably 0.006 mass % or more, and preferably 20 mass % or less, more preferably 10 mass % or less, further preferably 1 mass % or less, further preferably 0.1 mass % or less and further preferably 0.01 mass % or less from the viewpoint of ensuring washing performance.

In the detergent liquid, the mass ratio of the content of component (A) to the content of component (B), (A)/(B), is preferably 0.1 or more, more preferably 0.5 or more and further preferably 0.8 or more, and preferably 10 or less, more preferably 3 or less and further preferably 1.2 or less from the viewpoints of imparting softness and ensuring washing performance.

In the detergent liquid, the mass ratio of the content of component (A1) to the content of component (B1), (A1)/(B1), is preferably 0.1 or more, more preferably 0.5 or more and further preferably 1 or more, and preferably 10 or less, more preferably 3 less and further preferably 1.5 or less from the viewpoints of imparting softness and ensuring washing performance.

The detergent liquid has a temperature of preferably 0° C. or more, more preferably 3° C. or more and further preferably 5° C. or more from the viewpoint of being able to have further improved detergency against stains adhered to fibers, and preferably 70° C. or less and more preferably 60° C. or less from the viewpoint of being able to more softly finish fibers constituting clothes without removing too much of oils included in the fibers themselves.

The detergent liquid has a pH at 20° C. of preferably 3 or more and more preferably 4 or more from the viewpoint of being able to have further improved detergency against stains adhered to fibers, and preferably 10 or less and more preferably 9 or less from the viewpoint of being able to more softly finish fibers. The pH can be measured by the aforementioned measuring method.

In recent years, washing machines have increased in size, and a bath ratio, which is represented by the ratio between the mass of clothes (kg) and the amount of water in a detergent liquid (liter), i.e., water amount in detergent liquid (liter)/mass of clothes (kg) (hereinafter, this ratio may also be referred to as the bath ratio) tends to be a smaller value. When the bath ratio is smaller in the case of using a domestic washing machine, agitation during washing may cause greater rubbing of fibers against one another, resulting in impaired softness of fibers. The washing method of the present invention is capable of softly finishing fibers even under the condition of washing at a small bath ratio. The bath ratio is preferably 2 or more, more preferably 3 or more, further preferably 4 or more and furthermore preferably 5 or more from the viewpoint of more softly finishing fibers, and preferably 45 or less, more preferably 40 or less, further preferably 30 or less and furthermore preferably 20 or less from the viewpoint of maintaining detergency.

The washing method of the present invention is capable of more softly finishing fibers even if the washing time is short. The washing time is preferably 1 minute or more, more preferably 2 minutes or more and further preferably 3 minutes or more in terms of easily removing stains adhered to fibers or from the viewpoint of being able to more softly finish fibers, and preferably 90 minutes or less, more preferably 60 minutes or less, further preferably 30 minutes or less and furthermore preferably 15 minutes or less from the viewpoint of being able to more softly finish fibers.

The method for washing fibers of the present invention is suitably applied to methods in which fibers are immersed in scouring liquids while being fed on rollers or the like or rotary washing methods. The rotary washing methods mean washing methods in which fibers not fixed to rotating devices rotate around rotation axes together with detergent liquids. The rotary washing methods can be implemented by rotary washing machines. Thus, in the present invention, fibers are preferably washed in rotary washing machines in terms of more softly finishing fibers. Specific examples of rotary washing machines include drum-type washing machines, pulsator-type washing machines or agitator-type washing machines. Commercially available rotary washing machines of those kinds can be used.

In the washing method of the present invention, a textile product is washed with a predetermined detergent liquid and thereafter rinsed with water. Rinsing with water may be carried out as is done in publicly-known manners during washing clothes or the like.

The present invention discloses, in addition to the embodiments mentioned above, the following aspects.

<1>

A detergent composition containing (A) an anionic surfactant, (B) a nonionic surfactant and water,

wherein the composition contains

(A1) an anionic surfactant having a hydrocarbon group and an acid- or salt-form sulfonic acid group [hereinafter referred to as component (A1)] as component (A), and

one or two or more nonionic surfactants [hereinafter referred to as component (B1)] selected from the group consisting of (B1-1) a nonionic surfactant having a linear hydrocarbon group with 8 or more and 10 or less carbons [hereinafter referred to as component (B1-1)] and (B1-2) a nonionic surfactant having a branched hydrocarbon group with 8 or more and 22 or less carbons [hereinafter referred to as component (B1-2)] as component (B).

<2>

The detergent composition according to <1>, wherein component (A1) is one or two or more anionic surfactants selected from an internal olefin sulfonate salt (hereinafter referred to as IOS), an alkylbenzene sulfonate salt, an alpha-sulfo fatty acid ester salt and a dialkyl sulfosuccinate salt.

<3>

The detergent composition according to <2>, wherein the composition contains IOS as component (A1).

<4>

The detergent composition according to <2> or <3>, wherein the composition contains IOS having a hydrocarbon group with 8 or more and 22 or less carbons as component (A1).

<5>

The detergent composition according to any of <2> to <4>, wherein the composition contains IOS having a hydrocarbon group with 18 carbons as component (A1).

<6>

The detergent composition according to any of <4> or <5>, wherein, in IOS, the proportion of IOS with a sulfonic acid group present at position 2 of a hydrocarbon group is preferably 5% or more, more preferably 10% or more and further preferably 20% or more, and preferably 45% or less and more preferably 30% or less on a mass basis.

<7>

The detergent composition according to any of <4> to <6>, wherein, in IOS, the proportion of IOS with a sulfonic acid group present at position 1 of a hydrocarbon group is preferably 0.2% or more, more preferably 1% or more and further preferably 2% or more, and preferably 20% or less, more preferably 10% or less, further preferably 5% or less and furthermore preferably 3% or less on a mass basis.

<8>

The detergent composition according to any of <2> to <7>, wherein, in IOS, the proportion of IOS with 18 or more and 22 or less carbons is preferably 50 mass % or more, more preferably 70 mass % or more, further preferably 80 mass % or more, furthermore preferably 90 mass % or more, furthermore preferably 95 mass % or more and furthermore preferably 97 mass % or more, and preferably 100 mass % or less, or 100 mass %.

<9>

The detergent composition according to any of <2> to <8>, wherein, in IOS, and further, in IOS having a hydrocarbon group with 8 or more and 22 or less carbons, the molar ratio of H species to O species (H species/O species) is preferably 50/50 or more and more preferably 70/30 or more, and preferably 95/5 or less and more preferably 90/10 or less.

<10>

The detergent composition according to any of <1> to <9>, wherein the proportion of component (A1) in component (A) is 30 mass % or more and 100 mass % or less.

<11>

The detergent composition according to any of <1> to <10>, wherein the proportion of component (A1) in component (A) is preferably 50 mass % or more, more preferably 70 mass % or more, further preferably 90 mass % or more and further preferably 100 mass %, and preferably 100 mass % or less, or 100 mass %.

<12>

The detergent composition according to any of <1> to <11>, wherein component (B1) is a nonionic surfactant with an HLB of 11.5 or more and further 12.5 or more, and 15.4 or less and further 15.1 or less.

<13>

The detergent composition according to any of <1> to <12>, wherein the composition contains one or two or more nonionic surfactants [hereinafter referred to as component (B1)] selected from (B1-1) a nonionic surfactant having a linear hydrocarbon group with 8 or more and 10 or less carbons [hereinafter referred to as component (B1-1)] and (B1-2) a nonionic surfactant having a branched hydrocarbon group with 8 or more and 22 or less carbons [hereinafter referred to as component (B1-2)] as component (B).

<14>

The detergent composition according to <13>, wherein component (B1-1) is a nonionic surfactant represented by the following general formula (b1-1):

R¹—O—(A¹O)ₙ₁—R² (b1-1)

wherein R¹ is a linear hydrocarbon group with 8 or more and 10 or less carbons; R² is a hydrogen atom or a methyl group; A¹O group is one or more groups selected from an ethyleneoxy group and a propyleneoxy group; and n1 is an average number of added moles and a number selected from the numbers 3 or more and 50 or less.
<15>

The detergent composition according to <14>, wherein A¹O group in the general formula (b1-1) is a group including an ethyleneoxy group.

<16>

The detergent composition according to <14> or <15>, wherein n1 in (b1-1) is a number selected from numbers preferably 5 or more and more preferably 7 or more, and preferably 20 or less and more preferably 10 or less.

<17>

The detergent composition according to any of <13> to <16>, wherein component (B1-1) is a polyoxyalkylene decyl ether.

<18>

The detergent composition according to any of <13> to <17>, wherein component (B1-2) is a nonionic surfactant represented by the following general formula (b1-2):

R³—O—(A²O)ₙ₂—R⁴ (b1-2)

wherein R³ is a branched hydrocarbon group with 8 or more and 22 or less carbons; R⁴ is a hydrogen atom or a methyl group; A²O group is one or more groups selected from an ethyleneoxy group and a propyleneoxy group; and n2 is an average number of added moles and a number selected from the numbers 3 or more and 50 or less.
<19>

The detergent composition according to <18>, wherein, in the general formula (b1-2), R³ is a branched hydrocarbon group with 8 or more and 22 or less carbons, and further, R³ is a group selected from a branched alkyl group, a linear secondary alkyl group, a branched alkenyl group and a linear secondary alkenyl group, and further a group selected from a branched alkyl group and a linear secondary alkyl group.

<20>

The detergent composition according to <18> or <19>, wherein A²O group in the general formula (b1-2) is a group including an ethyleneoxy group.

<21>

The detergent composition according to any of <18> to <20>, wherein n2 in the general formula (b1-2) is a number selected from numbers preferably 5 or more, more preferably 7 or more and further preferably 9 or more, and preferably 20 or less and more preferably 10 or less.

<22>

The detergent composition according to any of <18> to <21>, wherein component (B1-2 is an alkylene oxide adduct of a Guerbet alcohol with 10 carbons.

<23>

The detergent composition according to <1> to <22>, wherein the composition contains a nonionic surfactant other than component (B1) [hereinafter referred to as component (B2)] as component (B).

<24>

The detergent composition according to <23>, wherein component (B2) is a nonionic surfactant represented by the following general formula (b2):

R⁵—O—(A³O)ₙ₃—R⁶ (b2)

wherein R⁵ is a linear hydrocarbon group with 11 or more carbons or a branched hydrocarbon group with 23 or more carbons; R⁶ is a hydrogen atom or a methyl group; A³O group is one or more groups selected from an ethyleneoxy group and a propyleneoxy group; and n3 is an average number of added moles and a number selected from the numbers 3 or more and 50 or less.
<25>

The detergent composition according to <23> or <24>, wherein R⁵ in the general formula (b2) is a linear hydrocarbon group with 11 or more carbons or a branched hydrocarbon group with 23 or more carbons.

<26>

The detergent composition according to <25>, wherein A³O group in the general formula (b2) is a group including as ethyleneoxy group.

<27>

The detergent composition according to <1> to <26>, wherein n3 in the general formula (b2) is a number selected from numbers preferably 5 or more and more preferably 7 or more, and preferably 30 or less, more preferably 25 or less and further preferably 21 or less.

<28>

The detergent composition according to any of <1> to <27>, wherein the proportion of component (B1) in component (B) is preferably 30 mass % or more, more preferably 50 mass % or more and further preferably 70 mass % or more, and preferably 100 mass % or less, more preferably 90 mass % or less and further preferably 80 mass % or less, or 100 mass %.

<29>

The detergent composition according to any of <1> to <28>, wherein the composition contains component (A) in an amount of preferably 0.01 mass % or more, more preferably 0.1 mass % or more, further preferably 0.5 mass % or more, further preferably 1 mass % or more, further preferably 3 mass % or more and further preferably 5 mass % or more, and preferably 70 mass % or less, more preferably 60 mass % or less, further preferably 40 mass % or less, further preferably 20 mass % or less, further preferably 10 mass % or less and further preferably 8 mass % or less.

<30>

The detergent composition according to any of <1> to <29>, wherein the composition contains component (A1) in an amount of preferably 0.01 mass % or more, more preferably 0.1 mass % or more, further preferably 0.5 mass % or more, further preferably 1 mass % or more, further preferably 3 mass % or more and further preferably 5 mass % or more, and preferably 70 mass % or less, more preferably 60 mass % or less, further preferably 40 mass % or less, further preferably 20 mass % or less, further preferably 10 mass % or less and further preferably 8 mass % or less.

<31>

The detergent composition according to any of <1> to <30>, wherein the composition contains component (B) in an amount of preferably 0.01 mass % or more, more preferably 0.1 mass % or more, further preferably 0.5 mass % or more, further preferably 1 mass % or more, further preferably 3 mass % or more, further preferably 4 mass % or more and further preferably 5 mass % or more, and preferably 70 mass % or less, more preferably 40 mass % or less, further preferably 20 mass % or less, further preferably 10 mass % or less and further preferably 8 mass % or less.

<32>

The detergent composition according to any of <1> to <31>, wherein the composition contains component (B1) in an amount of preferably 0.01 mass % or more, more preferably 0.1 mass % or more, further preferably 0.5 mass % or more, further preferably 1 mass % or more, further preferably 3 mass % or more, further preferably 4 mass % or more and further preferably 5 mass % or more, and preferably 70 mass % or less, more preferably 40 mass % or less, further preferably 20 mass % or less, further preferably 10 mass % or less and further preferably 8 mass % or less.

<33>

The detergent composition according to any of <1> to <32>, wherein the mass ratio of the content of component (A) to the content of component (B), (A)/(B), is preferably 0.1 or more, more preferably 0.5 or more and further preferably 0.8 or more, and preferably 10 or less, more preferably 3 or less and further preferably 1.2 or less.

<34>

The detergent composition according to any of <1> to <33>, wherein the mass ratio of the content of component (A1) to the content of component (B1), (A1)/(B1), is preferably 0.1 or more, more preferably 0.5 or more and further preferably 1 or more, and preferably 10 or less, more preferably 3 or less and further preferably 1.5 or less.

<5>

The detergent composition according to any of <1> to <34>, wherein the composition contains water in an amount of 20 mass % or more and further 30 mass % or more, and 99 mass % or less and further 98 mass % or less.

<36>

The detergent composition according to any of <1> to <35>, wherein the pH at 20° C. is preferably 3 or more and more preferably 4 or more, and preferably 1 or less and more preferably 12 or less.

<37>

The detergent composition according to any of <1> to <36>for use in textile products.

<38>

A method for washing a textile product including, washing the textile product with a detergent liquid obtained by mixing the detergent composition according to any of <1> to <37> and water, and thereafter rinsing the textile product with water.

<39>

The method for washing a textile product according to <38>, wherein the water mixed with the detergent composition and the water used for rinsing each have a hardness selected from the range of 1° dH or more, further 2° dH or more and further 3° dH or more, and 30° dH or less, further 25° dH or less, further 20° dH or less, further 18° dH or less and further 15° dH or less.

<40>

The method for washing a textile product according to <38> or <39>, wherein the content of component (A) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less.

<41>

The method for washing a textile product according to any of <38> to <40>, wherein the content of component (A1) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less.

<42>

The method for washing a textile product according to any of <38> to <41>, wherein the content of component (B) in the detergent liquid is preferably 0.001 mass % or more, more preferably 0.005 mass % or more and further preferably 0.008 mass % or more, and preferably 20 mass % or less, more preferably 10 mass % or less, further preferably 1 mass % or less, further preferably 0.1 mass % or less and further preferably 0.01 mass % or less.

<43>

The method for washing a textile product according to any of <38> to <42>, wherein the content of component (B1) in the detergent liquid is preferably 0.001 mass % or more, more preferably 0.005 mass % or more and further preferably 0.006 mass % or more, and preferably 20 mass % or less, more preferably 10 mass % or less, further preferably 1 mass % or less, further preferably 0.1 mass % or less and further preferably 0.01 mass % or less.

<44>

The method for washing a textile product according to any of <38> to <43>, wherein the mass ratio of the content of component (A) to the content of component (B) in the detergent liquid, (A)/(B), is preferably 0.1 or more, more preferably 0.5 or more and further preferably 0.8 or more, and preferably 10 or less, more preferably 3 or less and further preferably 1.2 less.

<45>

The method for washing a textile product according to any of <38> to <44>, wherein the mass ratio of the content of component (A1) to the content of component (B1) in the detergent liquid, (A1)/(B1), is preferably 0.1 or more, more preferably 0.5 or more and further preferably 1 or more, and preferably 10 or less, more preferably 3 or less and further preferably 1.5 or less.

<46>

The method for washing a textile product according to any of <38> to <45>, wherein the temperature of the detergent liquid is preferably 0° C. or more, more preferably 3° C. or more and further preferably 5° C. or more, and preferably 70° C. or less and more preferably 60° C. or less.

<47>

The method for washing a textile product according to any of <38> to <46>, wherein the pH of the detergent liquid at 20° C. is preferably 3 or more and more preferably 4 or more, and preferably 10 or less and more preferably 9 or less.

<48>

The method for washing a textile product according to any of <38> to <47>, wherein the bath ratio is preferably 2 or more, more preferably 3 or more, further preferably 4 or more and furthermore preferably 5 or more, and preferably 45 or less, more preferably 40 or less, further preferably 30 or less and furthermore preferably 20 or less.

<49>

The method for washing a textile product according to any of <38> to <48>, wherein the washing time is preferably 1 minute or more, more preferably 2 minutes or more and further preferably 3 minutes or more, and preferably 90 minutes or less, more preferably 60 minutes or less, further preferably 30 minutes or less and furthermore preferably 15 minutes or less.

<50>

The method for washing a textile product according to any of <38> to <49>, wherein fibers are washed is a rotary washing machine.

### EXAMPLES

### [1] Evaluation of Detergency

### <Washing Test>

### (Washing Step)

A washing operation was performed using a tergotometer (manufactured by Ueshima Seisakusho Co., Ltd., MS-8210). As water used for washing, deionized water to which calcium chloride and magnesium chloride were added in proportions of 2:1 by mass ratio in different concentrations to adjust the hardness to 5, 10, 15 and 20° dH (hereinafter referred to as adjusted water) was used. Each of the detergent compositions listed in Tables 1 and 2 was mixed with each adjusted water above to obtain a detergent liquid containing active components of the detergent composition in a concentration of 0.15 mass %. In a 1-liter stainless beaker for washing tests, 0.6 L of the detergent liquid and four pieces of sebum/pigment mixture-soiled cotton cloth (manufactured by WFK, WFK10D) cut into 6 cm×6 cm squares were placed. Pieces of cotton cloth (knitted cotton cloth manufactured by Tanigashira-Shoten corporation) cut into 6 cm×6 cm squares were added to adjust the bath ratio to 20. Washing was carried out at 85 rpm for 10 minutes with the detergent liquid whose temperature was set to 40° C.

### (Rinsing Step and Drying Step)

After washed, the pieces of cloth were rinsed for 30 seconds with adjusted water having the same hardness as the adjusted water used to prepare the detergent liquid under the same conditions as those in the washing step except for the absence of the detergent composition and the time, thereafter dewatered, and dried with an ironing press machine.

### <Method for Evaluating Washing Rate>

The washing rates of the four pieces of sebum/pigment mixture-soiled cotton cloth obtained in the above washing test were each measured by the following method, and the average value thereof was determined.

The reflectance at 550 nm of the original cloth before soiling (manufactured by WFK, WFK10A) and before and after washing was measured with a colorimeter (manufactured by NIPPON DENSHOKU INDUSTRIES CO., LTD., Z-300A), and the washing rate (%) was determined by the following formula. The values in Tables 1 and 2 are the average values of the washing rates of four pieces.

The washing rates (%) of four pieces were each measured by the following method, and the average values thereof were determined. The results are shown in Tables 1 and 2.

Washing rate (%)=100×[(reflectance after washing−reflectance before washing)/(reflectance of original cloth−reflectance before washing)]

### [2] Evaluation of Softness

### <Pretreatment of Softness Evaluation Fibers>

1.7 kg of cotton towels (manufactured by Takei Towel Corporation, cotton 100%, No. 3700) was washed in the standard course of a fully automatic washing machine (manufactured by Panasonic Corporation, NA-F702P) (adding 5.0 g of EMULGEN 108 (manufactured by Kao Corporation) as a detergent during washing, in 47 L of water, washed for 12 minutes and rinsed twice, and dewatered for 3 minutes) twice in a cumulative manner, thereafter washed in the standard course with tap water alone (in 47 L of water, washed for 12 minutes and rinsed twice, and dewatered for 3 minutes) three times in a cumulative manner, and dried for 24 hours under an environment of 23° C. and 45% RH to obtain pretreated towels.

### <Washing of Softness Evaluation Fibers>

The fibers to be evaluated were washed in an electric bucket washing machine (manufactured by Panasonic Corporation, N-BK2). As water used for washing, deionized water to which calcium chloride and magnesium chloride were added in proportions of 2:1 by mass ratio to adjust the hardness to 10° dH was used. Each of the detergent compositions listed in Tables 1 and 2 was mixed with the above washing water to obtain a detergent liquid containing the detergent composition in a concentration of 0.15 mass %. 4 L of the detergent liquid and three of the above pretreated towels (manufactured by Takei Towel Corporation, cotton 100%, No. 3700) were placed in a 6-liter washing bucket, and the bath ratio was adjusted to 20. The water flow was set to the standard one, with which washing was carried out for 10 minutes. After washing, dewatering was carried out for three minutes in a two-tank washing machine (manufactured by Hitachi, Ltd., PS-H35L). An operation including pouring 4.0 L of the above washing water into the above bucket washing machine again, placing the dewatered towels therein, rinsing them for three minutes, and then dewatering them for three minutes in the two-tank washing machine was repeated twice. After dewatered, they were left alone and dried for 12 hours under the conditions of 20° C. and 43% RH to obtain washed towels.

### <Evaluation of Softness>

Two persons skilled in textures of fibers gave marks to each of the washed towels in softness and scrooping feelings according to the following criteria, and the average of those given by the two was calculated. The results are shown in Tables 1 and 2.

−1 . . . the finished cotton towel is not softer than that treated with the composition of comparative example 1

0 . . . the finished cotton towel is as soft as that treated with the composition of comparative example 1

1 . . . the finished cotton towel is slightly softer than that treated with the composition of comparative example 1

2 . . . the finished cotton towel is softer than that treated with the composition of comparative example 1

3 . . . the finished cotton towel is much softer than that treated with the composition of comparative example 1

### [3] Evaluation of Low-Temperature Stability

10 ml of each detergent composition was put into a Maruemu screw bottle (No. 4) and placed in a constant temperature chamber at 0° C. for three days, and after that, the presence or absence of precipitates was visually observed. In the tables, “Good” means that no precipitates were observed.

TABLE 1

| | | | | | | | Comparative |
|---|---|---|---|---|---|---|---|
| | | | | | | Example | example |
| | | | | | | 1 | 1 |
| Liquid | Formulation | (A) | (A1) | A1-1 | | 5.77 | 9.01 |
| detergent | amount | (B) | (B1) | (B1-2) | B1-2-1 | 5.00 | — |

| | | | | | |
|---|---|---|---|---|---|
| composition | (mass %) | (B2) | B2-1 | 1.60 | — |

| | | |
|---|---|---|
| Water | Balance | Balance |
| Total | 100 | 100 |

| | | |
|---|---|---|
| Proportion of (A1) in (A) (mass %) | 100 | 100 |
| Proportion of (B1) in (B) (mass %) | 75.8 | — |

| | | | |
|---|---|---|---|
| Washing | 5° DH | 48.6 | 42.4 |
| rate | 10° DH | 38.0 | 24.3 |
| (%) | 15° DH | 35.8 | 23.6 |
| | 20° DH | 31.3 | 21.1 |

| | | |
|---|---|---|
| Softness | 2.5 | 0 |
| Scrooping feeling | None | None |
| Storage stability | Good | Turbid |

TABLE 2

| | | | | | | | | | | | Comparative | |
|---|---|---|---|---|---|---|---|---|---|---|---|---|
| | | | | | | Example | | | | | example | |
| | | | | | | 2 | 3 | 4 | 5 | 6 | 2 | 3 |
| Liquid | Formulation | (A) | (A1) | A1-2 | | 5.77 | 5.77 | 5.77 | 5.77 | 4.77 | 9.37 | 9.01 |
| detergent | amount | | | A1-3 | | — | — | — | — | 1.00 | — | — |
| composition | (mass %) | (B) | (B1) | (B1-1) | B1-1-1 | 5.00 | 6.60 | — | — | — | — | — |
| | | | | (B1-2) | B1-2-1 | — | — | 6.60 | 5.00 | 5.00 | — | — |

| | | | | | | | | |
|---|---|---|---|---|---|---|---|---|
| (B2) | B2-1 | 1.60 | — | — | 1.60 | 1.60 | 2.60 | — |

| | | | | | | | |
|---|---|---|---|---|---|---|---|
| Water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| Proportion of (A1) in (A) (mass %) | 100 | 100 | 100 | 100 | 100 | 100 | 100 |
| Proportion of (B1) in (B) (mass %) | 75.8 | 100 | 100 | 75.8 | 75.8 | — | 100 |

| | | | | | | | | |
|---|---|---|---|---|---|---|---|---|
| Washing | 5° DH | 45.8 | 48.2 | 44.3 | 45.1 | 46.3 | 34.0 | 43.4 |
| rate | 10° DH | 32.8 | 34.1 | 35.9 | 34.0 | 37.2 | 29.0 | 25.7 |
| (%) | 15° DH | 33.2 | 42.5 | 39.4 | 37.8 | 42.8 | 36.0 | 25.4 |
| | 20° DH | 34.6 | 32.3 | 29.5 | 36.4 | 40.3 | 34.6 | 27.4 |

| | | | | | | | |
|---|---|---|---|---|---|---|---|
| Softness | 2.5 | 1.5 | 1.5 | 2.5 | 2.0 | 0 | 0 |
| Scrooping feeling | None | None | None | None | None | None | None |
| Storage stability | Good | Good | Good | Good | Good | Turbid | Turbid |

The components in the tables are listed below. The mass percentage of component (A1) is based on the amount of an acid-form compound of component (A1).
A1-1: a sodium internal olefin sulfonate with 18 carbons, in which the content of a sodium internal olefin sulfonate with a sulfonic acid group present at position 2 was 28.4 mass %, the content of an olefin sulfonate salt having a double bond at the end of the carbon chain was 2.4 mass %, and the mass ratio of hydroxy species/olefin species was 80/20. Further, in A1-1, the content of a raw material internal olefin was 2.1 mass % and that of an inorganic compound was 2.3 mass %. A1-1 can be produced, for example, by the following method of production example 1.

### Production Example 1 (Production of Sodium Internal Olefin Sulfonate with 18 Carbons)

7000 parts by mass of 1-octadecanol (manufactured by Kao Corporation, “KALCOL 8098”) and 700 parts by mass of γ-alumina (manufactured by Strem Chemicals, Inc.) as a catalyst are prepared in a flask with a stirrer and a reaction is carried out under stirring at 280° C. with nitrogen flowing through the system to obtain a crude internal olefin. The crude internal olefin is distilled at 148-158° C. and 0.5 mmHg to obtain an internal olefin with 18 carbons having an olefin purity of 100%. The internal olefin and a sulfur trioxide gas with an SO₃ concentration of 2.8 volume % are flowed through a thin-film sulfonation reactor at a reaction molar ratio (SO₃/internal olefin) of 1.005 to carry out a sulfonation reaction.

The resultant sulfonated product is neutralized with an aqueous solution prepared from sodium hydroxide in an amount 1.05 molar times a theoretical acid value for 1 hour at 30° C. The neutralized product is hydrolyzed by heating for 1 hour in an autoclave at 170° C. to produce a sodium internal olefin sulfonate with 18 carbons.
A1-2: a potassium internal olefin sulfonate with 18 carbons, in which the content of a potassium internal olefin sulfonate with a sulfonic acid group present at position 2 was 16.0 mass % and the mass ratio of hydroxy species/olefin species was 80/20.
A1-3: a sodium dodecylbenzene sulfonate, product name: NEOPELEX G-25, manufactured by Kao Corporation
B1-1-1: a nonionic surfactant with an HLB of 13.3 obtained by adding an average of 7 moles of ethylene oxide to a linear alcohol with 10 carbons
B1-2-1: a nonionic surfactant with an HLB of 14.3 obtained by adding an average of 9 moles of ethylene oxide to a Guerbet alcohol with 10 carbons
B2-1: a nonionic surfactant with an HLB of 16.6 obtained by adding an average of 21 moles of ethylene oxide to a linear primary alcohol with 12 carbons

1. A detergent composition comprising (A) an anionic surfactant [hereinafter referred to as component (A)], (B) a nonionic surfactant [hereinafter referred to as component (B)] and water,
wherein the composition comprises
(A1) an anionic surfactant having a hydrocarbon group and an acid- or salt-form sulfonic acid group [hereinafter referred to as component (A1)] as the component (A), and
one or more nonionic surfactants [hereinafter referred to as component (B1)] selected from the group consisting of (B1-1) a nonionic surfactant having a linear hydrocarbon group with 8 or more and 10 or less carbons [hereinafter referred to as component (B1-1)] and (B1-2) a nonionic surfactant having a branched hydrocarbon group with 8 or more and 22 or less carbons [hereinafter referred to as component (B1-2)] as the component (B).

2. The detergent composition according to claim 1, wherein the component (A1) is one or more anionic surfactants selected from the group consisting of an internal olefin sulfonate salt, an alkylbenzene sulfonate salt, an alpha-sulfo fatty acid ester salt and a dialkyl sulfosuccinate salt.

3. The detergent composition according to claim 1, wherein the composition comprises an internal olefin sulfonate salt as the component (A1).

4. The detergent composition according to claim 1, wherein the composition comprises an internal olefin sulfonate salt having a hydrocarbon group with 18 carbons as the component (A1).

5. The detergent composition according to claim 1, wherein a proportion of the component (A1) in the component (A) is 30 mass % or more and 100 mass % or less.

6. The detergent composition according to claim 1, wherein the component (B1) is a nonionic surfactant with an HLB of 11.5 or more and 15.4 or less.

7. The detergent composition according to claim 1, wherein the component (B1-1) is a polyoxyalkylene decyl ether.

8. The detergent composition according to claim 1, wherein the component (B1-2) is an alkylene oxide adduct of a Guerbet alcohol with 10 carbons.

9. The detergent composition according to claim 1, wherein a proportion of the component (B1) in the component (B) is 30 mass % or more and 100 mass % or less.

10. The detergent composition according to claim 1, wherein the composition comprises a nonionic surfactant other than the component (B1) as the component (B).

11. The detergent composition according to claim 1, wherein the composition comprises the component (A1) in an amount of 0.01 mass % or more and 70 mass % or less.

12. The detergent composition according to claim 1, wherein the composition comprises the component (B1) in an amount of 0.01 mass % or more and 70 mass % or less.

13. The detergent composition according to claim 1, wherein a mass ratio of the content of the component (A1) to the content of the component (B1), (A1)/(B 1), is 0.1 or more and 10 or less.

14. The detergent composition according to claim 1, adapted for use in textile products.

15. A method for washing a textile product comprising, washing the textile product with a detergent liquid obtained by mixing the detergent composition according to claim 1 and water, and thereafter rinsing the textile product with water.

16. The method for washing a textile product according to claim 15, wherein the water mixed with the detergent composition and the water used for rinsing each have a hardness of 1° dH or more and 30° dH or less.

17. The method for washing a textile product according to claim 15, wherein a mass ratio of the content of the component (A1) to the content of the component (B1) in the detergent liquid, (A1)/(B1), is 0.1 or more and 10 or less.

18. The method for washing a textile product according to claim 15, wherein a bath ratio is 2 or more and 45 or less.

19. The method for washing a textile product according to claim 15, wherein the textile product is washed in a rotary washing machine.
